(19) United States
(12) Patent Application Publication
(10) Pub. No.: US 2025/0148382 A1
(43) Pub. Date: May 8, 2025

(54) SYSTEM AND METHOD FOR DYNAMIC CLASSIFICATION OF CHASSIS POOLS FOR OPTIMIZING UTILIZATION OF CHASSIS RESOURCES OF A HUB BASED ON A DUAL-STREAM RESOURCE OPTIMIZATION

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,863

(22) Filed: Oct. 10, 2024

Related U.S. Application Data
(63) Continuation-in-part of application No. 18/501,608, filed on Nov. 3, 2023, now Pat. No. 12,217,199.

(51) Int. Cl. G06Q 10/0631; G06Q 10/087

(52) U.S. Cl. CPC G06Q 10/06311; G06Q 10/087

(57) ABSTRACT

Systems and techniques for enhancing the efficiency and utility of chassis pools within a hub by providing functionality for dynamic classification of chassis pools associated with the hub. In embodiments, the dynamic classification of chassis pools may be used for optimizing the utilization of chassis resources of the hub based on a dual-stream resource optimization (DSRO). In embodiments, the functionality of a system implemented in accordance with the present disclosure for dynamic classification of chassis pools associated with a hub may include determining and/or setting a configuration for one or more dynamic chassis pool classifications that may include rulesets, guidelines, performance metrics, constraint, requirements, etc., and/or other information related to the management and operations of the chassis pools associated with the hub. A chassis optimization system may use the configured one or more dynamic chassis pool classifications to optimize the utilization of the chassis during operations of the hub.

### CROSS-REFERENCE TO RELATED APPLICATIONS

The present application is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entirety of which is herein incorporated by reference for all purposes.

### TECHNICAL FIELD

The present disclosure relates generally to resource optimization systems, and more particularly to systems and devices for dynamic classification of chassis pools for optimizing utilization of chassis resources of a hub based on a dual-stream resource optimization.

### BACKGROUND

Transportation hubs are pivotal in the coordination of operations vital for the reception, secure storage, sorting, and loading of goods for delivery. Intermodal hub facilities (IHFs) epitomize such hubs, serving as crucial crossroads where units—primarily containers laden with goods—are transferred between various modes of transport including rail, road, maritime, and aerial. These facilities are distinguished by their ability to manage units designed for multimodal transportation, acting as key nodes within the broader transportation network.

The operational dynamics of an IHF can be defined by two primary operational flows. In a first operational flow, units are introduced (or in-gated (IG)) into the IHF by customers, processed, and then loaded onto trains destined for specific locations. Upon reaching these destinations, the units are unloaded and readied for pickup by customers. Conversely, a second operational flow involves the unloading of inbound (IB) units from arriving trains, their processing, and subsequent pickup by customers at the IHF. The efficient handling of both IG and IB units underscores the essential role of IHF resources in managing the substantial volume of units transitioning through these facilities.

Despite the importance of these operations, current processes within IHFs suffer from significant inefficiencies, particularly in the realm of resource management during operations. Chassis, which are structures or frames (e.g., trailers, semitrailers, trucks, etc.) designed to securely transport containers, are at the heart of some of these inefficiencies. Typically, customers transport units into the IHF using chassis. Once inside, these units, along with their chassis, are temporarily stored until the unit is slated for an outbound train. At this juncture, the unit is detached from the chassis and loaded onto the train, freeing the chassis for subsequent use. Similarly, during the inbound flow, chassis are allocated to units for unloading from inbound trains, with these units and their chassis then stored awaiting customer pickup.

This system, while functional, is fraught with inefficiencies due to the static nature of chassis allocation and utilization. The lack of a dynamic, adaptable mechanism for chassis management leads to suboptimal use of these critical resources, resulting in increased waiting times for units and chassis, underutilization of available chassis, and operational bottlenecks that hinder the overall efficiency and capacity of IHF operations.

Compounding these inefficiencies is the current framework governing the provision of chassis resources for IHF operations. Chassis are typically managed in pools, where the chassis are considered shared resources supplied by a chassis provider and accessible to multiple customers. In such arrangements, any customer participating in a chassis pool may utilize any chassis from the chassis pool (e.g., a chassis from the pool may be used to hold a container belonging to the participating customer). This model implies that when a container associated with a customer participating in a chassis pool arrives at the IHF, the container can be unloaded from the inbound train and placed onto a chassis from the chassis pool. On the other hand, when a unit (e.g., a container on a chassis) is dropped off at the IHF by customer participating in a chassis pool, the chassis in the unit can be considered as part of the chassis pool, even if the chassis is currently occupied. In this case, when the container is ramped onto an outbound train freeing up the chassis, the chassis can be used to receive a container belonging to a customer that participates in the chassis pool.

However, a significant drawback of chassis pool framework is that chassis in a chassis pool are often not available to customers outside of that specific chassis pool, leading to further inefficiencies. The exclusivity of chassis pools can result in suboptimal allocation and use of these essential resources, exacerbating the challenges of managing peak demand periods and efficiently cycling chassis between various users and operations within the IHF. In some cases, within a pool, there may be an imbalance between the use of chassis by different participating customers. For example, a customer participating in a chassis pool may disproportionately consume the chassis pool supply, leaving few chassis for the other participating customers. As a result, the containers belonging to other participating customers may need to be stacked upon deramping and loaded onto the chassis when the chassis become available later. This may result in multiple lifts and may delay the pickup of the units when the customers show up because their container may be buried underneath a stack. Thus, the current chassis pool framework is not robust enough to handle the operational requirements of a typical hub.

### SUMMARY

The present disclosure achieves technical advantages as systems, methods, and computer-readable storage media that enhance the efficiency and utility of chassis pools within a hub by providing functionality for dynamic classification of chassis pools associated with the hub. In embodiments, the dynamic classification of chassis pools may be used for optimizing the utilization of chassis resources of the hub based on a dual-stream resource optimization (DSRO). In embodiments, the functionality of a system implemented in accordance with the present disclosure for dynamic classification of chassis pools associated with a hub may include functionality for determining and/or setting a configuration for one or more dynamic chassis pool classifications that may include rulesets, guidelines, performance metrics, constraint, requirements, etc., and/or other information related to the management and operations of the chassis pools associated with the hub. A chassis optimization system may use or leverage the configured one or more dynamic chassis pool classifications to optimize the utilization of the chassis during operations of the hub.

The present disclosure provides for a system integrated into a practical application with meaningful limitations as a system configured with a novel approach for the dynamic classification of chassis pools, which results in a significant improvement in the management and operational effectiveness of chassis resources. A system implemented in accordance with embodiments of the present disclosure includes functionality to dynamically classify chassis pools through a sophisticated DSRO approach. The technique disclosed herein not only facilitate the optimized allocation and utilization of chassis resources but also allows for the establishment of a highly adaptive operational environment. By implementing a system that incorporates rulesets, guidelines, performance metrics, constraints, and other pertinent criteria, the present disclosure ensures that chassis pools in a hub are managed in a manner that is both efficient and tailored to the specific requirements of the hub. The dynamic classification functionality empowers operators to adjust and refine chassis pool configurations before operations, and/or during operations, even in real-time, responding promptly to changes in demand, operational constraints, and other critical factors. This leads to a marked improvement in the utilization rates of chassis, reducing operational bottlenecks and enhancing overall productivity. The disclosure herein may alleviate the typical challenges associated with chassis shortages and misallocations, enhancing operational efficiency, reducing unnecessary lifts and handling, and ensuring a more predictable and reliable flow of units through the hub. Ultimately, the disclosed systems and methods represent a significant advancement in the field of logistics and supply chain management, offering considerable benefits in terms of resource optimization, operational flexibility, and cost efficiency, by providing a comprehensive, scalable, and adaptable framework for chassis pool management.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for optimizing resources in hubs. In doing so, the present disclosure goes well beyond a mere application the manual process to a computer. Accordingly, the claims herein necessarily provide a technological solution that overcomes a technological problem.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of allocating chassis resources of a hub based on dynamic classification of chassis pools associated with the hub. It is a further object of the disclosure to provide a system for allocating chassis resources of a hub based on dynamic classification of chassis pools associated with the hub, and a computer-based tool for allocating chassis resources of a hub based on dynamic classification of chassis pools associated with the hub. These and other objects are provided by the present disclosure, including at least the following embodiments.

In one particular embodiment, a method of allocating chassis resources of a hub based on dynamic classification of chassis pools associated with the hub is provided. The method includes configuring a plurality of chassis pool classification. In embodiments, a configuration of each of the plurality of chassis pool classifications includes a ruleset for managing utilization of chassis in a chassis pool. The method also includes obtaining an optimized operating schedule including a consolidated time-space network representing a consolidation operational stream and a deconsolidated time-space network representing a deconsolidation operational stream over a planning horizon. In embodiments, the optimized operating schedule includes one or more chassis recommendations to allocate chassis resources to containers arriving at the hub based on the plurality of chassis pool classifications. The method further includes receiving a container associated with a customer at the hub at a first time increment of the planning horizon, allocating a chassis to the container based on the optimized operating schedule, and automatically sending, during execution of the optimized operating schedule, a control signal to a controller to cause the container to be placed onto the chassis based on the optimized operating schedule.

In another embodiment, a system for allocating chassis resources of a hub based on dynamic classification of chassis pools associated with the hub is provided. The train yard management system comprises at least one processor and a memory operably coupled to the at least one processor and storing processor-readable code that, when executed by the at least one processor, is configured to perform operations. The operations include configuring a plurality of chassis pool classification. In embodiments, a configuration of each of the plurality of chassis pool classifications includes a ruleset for managing utilization of chassis in a chassis pool. The operations also include obtaining an optimized operating schedule including a consolidated time-space network representing a consolidation operational stream and a deconsolidated time-space network representing a deconsolidation operational stream over a planning horizon. In embodiments, the optimized operating schedule includes one or more chassis recommendations to allocate chassis resources to containers arriving at the hub based on the plurality of chassis pool classifications. The operations further include receiving a container associated with a customer at the hub at a first time increment of the planning horizon, allocating a chassis to the container based on the optimized operating schedule, and automatically sending, during execution of the optimized operating schedule, a control signal to a controller to cause the container to be placed onto the chassis based on the optimized operating schedule.

In yet another embodiment, a computer-based tool for allocating chassis resources of a hub based on dynamic classification of chassis pools associated with the hub is provided. The computer-based tool including non-transitory computer readable media having stored thereon computer code which, when executed by a processor, causes a computing device to perform operations. The operations include configuring a plurality of chassis pool classification. In embodiments, a configuration of each of the plurality of chassis pool classifications includes a ruleset for managing utilization of chassis in a chassis pool. The operations also include obtaining an optimized operating schedule including a consolidated time-space network representing a consolidation operational stream and a deconsolidated time-space network representing a deconsolidation operational stream over a planning horizon. In embodiments, the optimized operating schedule includes one or more chassis recommendations to allocate chassis resources to containers arriving at the hub based on the plurality of chassis pool classifications. The operations further include receiving a container associated with a customer at the hub at a first time increment of the planning horizon, allocating a chassis to the container based on the optimized operating schedule, and automatically sending, during execution of the optimized operating schedule, a control signal to a controller to cause the container to be placed onto the chassis based on the optimized operating schedule.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for dynamically classifying chassis pools associated with a hub in accordance with embodiments of the present disclosure.

FIG. 2 is a block diagram illustrating an example of dual-stream resource optimization (DSRO) system configured with capabilities and functionality for dynamically classifying chassis pools associated with a hub in accordance with embodiments of the present disclosure.

FIG. 3 is a block diagram of an exemplary chassis optimization system configured with functionality for optimizing utilization of chassis resources of a hub based on a DSRO in accordance with embodiments of the present disclosure.

FIG. 4 is a flowchart illustrating operations for allocating chassis to containers based on dynamic chassis pool classifications in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for enhancing the efficiency and utility of chassis pools within a hub by providing functionality for dynamically classifying chassis pools associated with the hub. In embodiments, the dynamic classifications of the chassis pools may be used for optimizing the utilization of chassis resources of the hub based on a dual-stream resource optimization (DSRO). In embodiments, the functionality of a system implemented in accordance with the present disclosure for dynamic classification of chassis pools associated with a hub may include functionality for determining and/or setting a configuration for one or more dynamic chassis pool classifications that may include rulesets, guidelines, performance metrics, constraints, requirements, etc., and/or other information related to the management and operations of the chassis pools associated with the hub. A chassis optimization system may use or leverage the configured one or more dynamic chassis pool classifications to optimize the utilization and/or allocation of the chassis resources during operations of the hub.

It is noted that the description that follows focuses on operations of a hub (e.g., an intermodal hub facility (IHF), a train yard, etc.) in which units (e.g., containers on chassis carrying goods) received from customers are processed through the hub for eventual loading onto outbound trains to be transported to their respective destinations, and/or received from inbound trains carrying the containers are unloaded onto chassis and placed onto parking lots for eventual pickup by customers. However, the techniques described herein may be applicable in any application in which resources may be used in different operations, and where the use of the resources may be shared by various processes such that optimization of the use of the resources may yield a better throughput for the system.

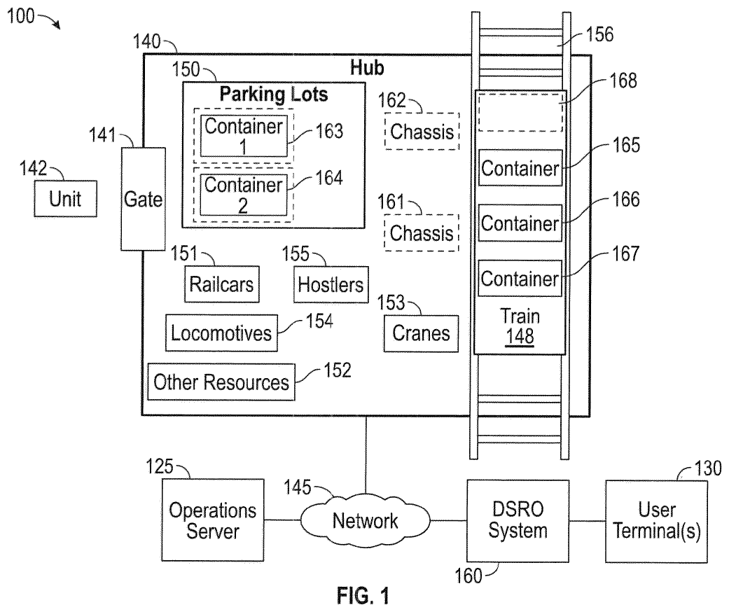

FIG. 1 is a block diagram of an exemplary system 100 configured with capabilities and functionality for dynamically classifying chassis pools associated with a hub in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide configuration parameters that may be used by system 100 to configure the rulesets for the dynamic chassis pool classification that may be used to manage the chassis pools, in accordance with embodiments of the present disclosure. In embodiments, user terminal 130 may be configured to communicate with other components of system 100.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Hub 140 may represent a hub (e.g., an IHF, a train station, etc.) in which units are processed as part of the transportation of the unit. In embodiments, a unit may include containers, trailers, etc., carrying goods. For example, a unit may include a chassis carrying a container, and/or may include a container. In embodiments, units may be in-gated (IG) into hub 140 (e.g., by a customer dropping the unit into hub 140). The unit, including the chassis and the container (e.g., the chassis carrying the container), may be temporarily stored in a parking space of parking lots 150, while the container awaits being assigned to an outbound train. Once assigned to an outbound train, and once the outbound train is being processed in the production tracks (e.g., production tracks 156), the chassis with the container is moved to the production tracks, where the container is removed from the chassis and the container is loaded onto the outbound train for transportation to the destination of the container. On the other side of operations, a container carrying goods may arrive at the hub via an inbound (IB) train (e.g., the IB train may represent an outbound train from another hub from which the container may have been loaded), may be unloaded from the IB train onto a chassis, and may be temporarily stored in a parking space of parking lots 150 for eventual pickup by a customer.

In embodiments, processing the units through the IG flow and the IB flow may involve the use of a wide variety of resources to consolidate the containers from customers into departing or outbound trains and/or to deconsolidate arriving or inbound trains into individual units (e.g., containers mounted on chassis) for pickup by customers. These resources may include hub personnel (hostler drivers, crane operators, etc.), parking lots, chassis, hostlers, cranes, tracks, railcars, locomotives, etc. These resources may be used to facilitate moving, storing, loading, unloading, etc. the containers through the operational flows of the hub. For example, parking lots 150 may be used to park or store units (e.g., containers mounted on chassis) while the containers are waiting to be loaded onto departing trains or waiting to be picked up by customers. Chassis 152 (e.g., including semitrailers, frames, etc.), and operators of chassis 152, may be used to securely mount containers while the containers are moved within hub 140. Hostlers 155 (e.g., including hostlers, trucks, forklifts, etc.) and operators of hostlers 155 may be used to transport or move the units (e.g., containers on chassis) within hub 140, such as moving units to be loaded onto an outbound train or to move units unloaded from inbound trains. Cranes 153 may be used to load containers onto departing trains (e.g., to unload units from chassis 152 and load the units onto outbound trains) and/or to unload containers from inbound trains (e.g., to unload units from inbound trains and load the units onto chassis 152). Railcars 151 may be used to transport the units in the train. For example, a train may be composed of one or more railcars, and the units may be loaded onto the railcars for transportation. Inbound trains may include one or more railcars including units that may be processed through the second flow, and outbound trains may include one or more railcars including units that may have been processed through the first flow. Railcars 151 may be assembled together to form a train. Locomotives 154 may include engines that may be used to power a train. Other resources 155 may include other resources not explicitly mentioned herein but configured to allow or facilitate units to be processed through the IG flow and/or the IB flow of operations of hub 140.

Hub 140 may be described functionally by describing the operations of hub 140 as comprising two distinct flows or streams. Units flowing through a first flow (e.g., an IG flow) may be received through gate 141 from various customers for eventual loading onto an appropriate outbound train. For example, customers may drop off individual units (e.g., unit 142 including a container being carried in a chassis) at hub 140. The individual units may be transported by the customers using chassis that may enter hub 140 through gate 141 carrying the units. The containers arriving through the IG flow may be destined for different destinations, and may be dropped off at hub 140 at various times of the day or night. As part of the IG flow, the containers arriving at hub 140, along with the chassis in which these containers arrive, may be assigned or allocated to one or more of parking lots 150, while these containers wait to be assigned to an outbound train bound to the respective destination of the containers. The containers may eventually be loaded onto the assigned outbound train to be taken to their respective destination.

Units flowing through a second flow (e.g., an IB flow) may arrive at hub 140 via an IB train (e.g., train 148 may arrive at hub 140 over railroad 156), carrying containers, such as containers 165, 166, 167, and/or other containers, which may eventually be unloaded from the arriving train to be placed onto chassis, parked in assigned parking spaces of parking lot 150 to be made available for delivery to (e.g., for pickup by) customers.

For example, unit 142, including a container being carried in a chassis, may be currently being dropped off into hub 140 by a customer as part of the IG flow of hub 140, and may be destined to a first destination. In this case, as part of the IG flow, unit 142 may be in-gated into hub 140 and may be assigned to a parking space in one of parking lots 150. In this example, container 1, which may be mounted on chassis 163, may have been introduced into the IG flow of hub 140 by a customer (e.g., the same customer or a different customer) previously dropping off container 1 and chassis 163 at hub 140 to be transported to some destination (e.g., the first destination or a different destination), and may have previously been assigned to a parking lot of parking lots 150, where container 1 may currently be waiting to be assigned and/or loaded onto an outbound train to be transported to the destination of container 1.

As part of the IG flow, the container in unit 142 and container 1 may be assigned to an outbound train. For example, in this particular example, train 148 may represent an outbound train that is schedule to depart hub 140 to the same destination as the container in unit 142 and container 1. In this example, the container in unit 142 and container 1 may be assigned to train 148. Train 148 may be placed on one of one or more production tracks 156 to be loaded. In this case, as part of the IG flow, train 148 is loaded (e.g., using one or more cranes 153) with containers, including the container in unit 142 and container 1. Once loaded, train 148 may depart to its destination as part of the IG flow.

With respect to the IB flow, train 148 may arrive at hub 140 carrying several containers, including containers 2 and 165-167. It is noted that, as part of the dual stream operations of hub 140, some resources are shared and, in this example, train 148 may arrive at hub 140 as part of the IB flow before being loaded with containers as part of the IG flow as described above. Train 148 may be placed on placed on one of one or more production tracks 156 to be unloaded a part of the IB flow. As part of the unloading operations, the containers being carried by train 148 and destined for hub 140, may be removed from train 148 (e.g., using one or more cranes 153) and each placed or mounted on a chassis. Once on the chassis, the containers are transported (e.g., using one or more hostlers 155) to an assigned parking space of parking lots 150 to wait to be picked up by respective customers at which point the containers and the chassis on which the containers are mounted may exit or leave hub 140.

In embodiments, operations server 125 may be configured to provide functionality for facilitating operations of hub 140. In embodiments, operations server 125 may include data and information related to operations of hub 140, such as current inventory of all hub resources (e.g., chassis, hostlers, drivers, lift capacity, parking lot and parking spaces, IG capacity limits, railcar, locomotives, tracks, etc.), and details on the various chassis pools operating in the hub 140. This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon, which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop and/or update an optimized operating schedule based on a DSRO for managing the resources of hub 140 over a planning horizon.

In embodiments, operations server 125 may provide functionality to manage the execution of the optimized operational schedule (e.g., an optimized operating schedule generated in accordance with embodiments of the present disclosure) over the planning horizon of the optimized operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. Particular to the present disclosure, the optimized operating schedule may include recommendations associated with the utilization and/or management of the chassis pools associated with the hub to optimize the utilization of chassis resources, such as recommendation related to chassis allocations operations.

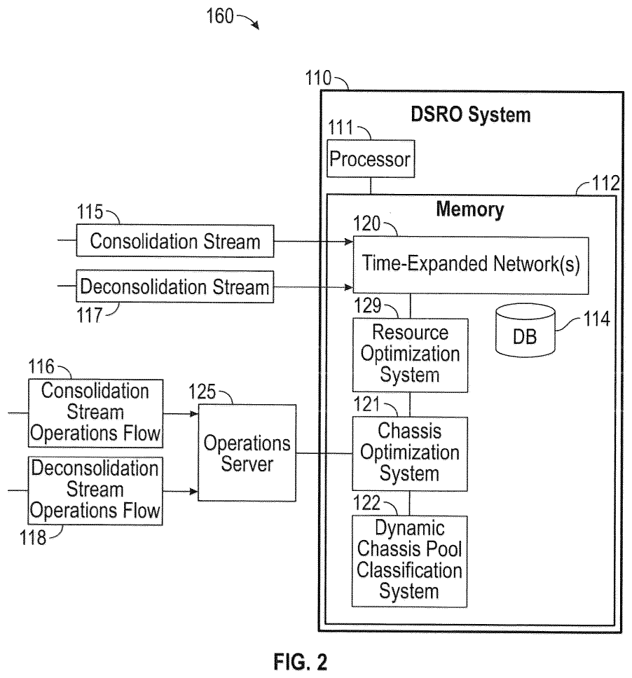

In embodiments, operations server 125 may manage execution of the optimized operational schedule by monitoring the consolidation stream operations flow (e.g., consolidation stream operations flow 116 of FIG. 2, which may represent the actual unit traffic flow through the IG flow during execution of the optimized operating schedule) and deconsolidation stream operations flow (e.g., deconsolidation stream operations flow 118 of FIG. 2, which may represent the actual unit traffic flow through the IB flow during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule. In embodiments, operations server 125 may operate to provide functionality that may be leveraged during execution of the optimized operational schedule over a planning horizon to ensure that unit throughput through the hub is maximized over the planning horizon.

The functionality of operations server 125 may include functionality to make recommendations related to allocations of chassis to arriving containers (e.g., containers being unloaded from an IB train) and/or to perform particular ramping and/or deramping operations in accordance and/or based on the optimized operating schedule over the planning horizon taking into consideration the dynamic chassis pool classifications configured in accordance with embodiments of the present disclosure. For example, operations server 125 may be configured to execute the optimized operational schedule by allocating chassis to containers in accordance with the rulesets included in the configuration of the various dynamic chassis pool classifications.

DSRO system 160 may be configured to manage resources of hub 140 based on a DSRO to maximize throughput through hub 140 in accordance with embodiments of the present disclosure. In particular, DSRO system 160 may be configured to provide the main functionality of system 100 to dynamically classify chassis pools associated with a hub that may be used to optimize the utilization of chassis resources of hub 140 to maximize the unit throughput of hub 140 over the planning horizon of the optimized operating schedule. For example, in embodiments, DSRO system 160 may dynamically classify chassis pools associated with a hub by leveraging the functionality of a dynamic chassis pool classification system (e.g., dynamic chassis pool classification system 122 of FIG. 2).

FIG. 2 is a block diagram illustrating an example of DSRO system 160 configured with capabilities and functionality for dynamically classifying chassis pools associated with a hub in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, chassis optimization system 121, dynamic chassis pool classification system 122, resource optimization system 129, and database 114. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a chassis optimization model, etc., and may also store information related to configurations of various dynamic chassis classifications, such as rulesets for implementing and/or managing the dynamic chassis classification, including operating rules, constraints, performance metrics, etc. associated with the dynamic chassis classifications. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of hub 140 may be represented as two distinct flows, an IG flow in which units arriving to hub 140 from customers are consolidated into outbound trains to be transported to their respective destinations, and an IB flow in which inbound trains arriving to hub 140 carrying units are deconsolidated into the units that are stored in parking lots while waiting to be picked up by respective customers. DSRO system 160 may be configured to represent the IG flow as consolidation stream 115 including a plurality of stages. Each stage of consolidation stream 115 may represent different operations or events that may be performed or occur to facilitate the IG flow of hub 140. DSRO system 160 may be configured to represent the IB flow as deconsolidation stream 117 including a plurality of stages. Each stage of deconsolidation stream 117 may represent different operations or events that may be performed or occur to facilitate the IB flow of hub 140.

In embodiments, the interaction between consolidation stream 115 and deconsolidation stream 117, with respect to the use of resources of hub 140, may be collaborative or competing. For example, the utilization of chassis resources within hub 140 between consolidation stream 115 and deconsolidation stream 117 may be collaborative. In this case, containers dropped off at hub 140 by customers are typically dropped off on a chassis. In this manner, when a container enters hub 140 through consolidation stream 115, an additional chassis is added to the chassis resource capacity of hub 140. The additional chassis may be currently being used by the container and as such may not be available, but the chassis may nonetheless be part of the chassis capacity of hub 140 since the additional chassis may become available and be used to receive a container once the container is removed from the chassis and loaded onto an outbound train. As such, consolidation stream 115, and specifically the ramping stage of consolidation stream 115, operates to supply or increase chassis resources to the chassis resource capacity of hub 140.

From deconsolidation stream 117′s perspective, containers arriving at hub 140 may require a chassis upon which to be mounted before the containers may be unloaded from the inbound train during the deramping stage of deconsolidation stream 117. The chassis used to receive an unloaded container is used from the current chassis resource capacity of hub 140 and once a container is placed or mounted on a chassis, the chassis is no longer available to receive another container. Once the containers are loaded onto their corresponding chassis during the deramping stage of deconsolidation stream 117, the containers are stored or parked in one or more of parling lots 150. Therefore, deconsolidation stream 117, and specifically the deramping stage of deconsolidation stream 117, operates to consume or decrease chassis resources from the chassis resource capacity of hub 140.

From the foregoing, it is noted that consolidation stream 115 supplies chassis resources and deconsolidation stream 117 consumes chassis resources and as such, consolidation stream 115 and deconsolidation stream 117 have a collaborative relationship in which one supplies resources and the other consumes the supplied resources. In this case, the capacity constraints of the chassis resources within hub 140 may create a big challenge in managing the chassis resources efficiently so that the unit throughput of hub 140 is not affected negatively.

In particular, as noted above, the current framework governing the provision of chassis resources for hub operations includes the management of chassis resources in chassis pools. A chassis pool may include one or more chassis (e.g., provided by one or more chassis providers who own the chassis, who may include the participating customers) that may be accessible to one or more customers participating in the chassis pool. In these arrangements, any customer participating in the chassis pool may utilize any of the chassis in the chassis pool to hold a container belonging to the customer. However, the current approach to managing chassis pools within transportation hubs presents a significant challenge that impacts the unit throughput within the hub, and in some cases even external operations. Chassis, as critical resources, are indispensable for the land transportation of containers. Their availability and effective management are thus crucial for preventing operational disruptions that could potentially bring hub activities to a standstill.

In current systems, shipper and consignee customers often enter into agreements with chassis providers to access a pool of chassis. These chassis pools allow customers to draw chassis for container transport from the chassis pool and return them to the chassis pool once the containers are processed (e.g., for use by another customer). Despite the apparent simplicity of this arrangement, the reality is fraught with complications due to the fluctuating demand for chassis among the multiple customers served by a single hub, which is impacted by a large number of factors, such as number of containers moved per customer, the dwell time of the containers, the chassis capacity of the hub, etc. The inventory levels of chassis in a hub are inherently unstable, influenced by the unpredictable demands of individual customers, making it challenging to maintain an optimal number of chassis that can satisfy all users' needs efficiently.

This variability in chassis demand and supply is exacerbated by the operational practices of hub customers. Shipper customers may bring their chassis when in-gating containers, integrating these chassis back into the chassis pool once their containers are loaded onto an outbound train for outbound transport. On the other hand, consignee customers draw chassis from the chassis pool to receive a container being deramped, and may even remove the chassis from the hub (e.g., after the consignee customer picks up the container from the hub), incrementally depleting the available chassis supply within the hub. A particularly active customer can thus disproportionately affect a chassis pool, consuming a substantial portion of the resource and leaving an inadequate supply for other users. In some cases, the active customer may draw more chassis from the chassis pools that may have been contributed by the active customer. This imbalance may lead to operational inefficiencies where units belonging to other customers must be stacked temporarily until a chassis becomes available. Such a situation may require multiple lifts of the containers, complicating and delaying the retrieval process for customers picking up the containers, especially when their unit, buried under others, requires excavation from the stack.

In embodiments, DSRO system 160 may be configured to enhance the efficiency and utility of chassis pools within a hub. For example, in embodiments, the functionality of DSRO system 160 to enhance the efficiency and utility of chassis pools within a hub may include leveraging the functionality of dynamic chassis pool classification system 122 to dynamically classify chassis pools associated with the hub. The dynamic chassis pool classifications generated and/or configured by dynamic chassis pool classification system 122 may be used by chassis optimization system 121 to optimize the utilization of chassis resources by allocating chassis to containers in accordance with the configuration of the dynamic chassis pool classifications. For example, chassis optimization system 121 may consider whether a dynamic chassis pool classification may be configured and may apply the configuration of the dynamic chassis pool classification when allocating chassis resources.

In embodiments, DSRO system 160 may be configured to generate one or more time-space networks 120 to represent consolidation stream 115 and deconsolidation stream 117, and to configure a DSRO model to use one or more time-space networks 120, over a planning horizon, to optimize the use of the resources of the hub that support the unit flow within the planning horizon in order to maximize the unit throughput of the hub over the planning horizon. In embodiments, the DSRO model may generate, based on the one or more time-space networks 120, an optimized operating schedule that includes one or more of a determined or predicted unit flow through one or more of the stages of each time-space network (e.g., the consolidation and/or deconsolidation stream time-space networks) at each time increment of the planning horizon, an indication of a resource deficit or surplus at one or more of the stages of each time-space network at each time increment of the planning horizon, and/or an indication or recommendation of a resource replenishment to be performed at one or more of the stages of each time-space network at each time increment of the planning horizon to increase the unit throughput of the hub. Particular to the present disclosure, the optimized operating schedule may include recommendations for ramping and/or deramping operations to synchronize consolidation stream 115 and deconsolidation stream 117 to ensure that the chassis resource supply of consolidation stream 115 and the chassis resource consumption of deconsolidation stream 117 is paired to maximize the unit throughput of the hub over the planning horizon, and recommendations of chassis allocations to containers. In embodiments, the operations of DSRO system 160 to generate recommendations for ramping and/or deramping operations may be based on the dynamic chassis pool classifications generated and/or configured by dynamic chassis pool classification system 122.

Chassis optimization system 121 may operate to provide further optimization of hub operations by providing one or more recommendations for managing the chassis resource capacity in the hub over the planning horizon to maximize the unit throughput over the planning horizon based on the unit traffic prediction. The recommendations may include replenishment (e.g., increasing the chassis capacity), repositioning (e.g., shifting the chassis capacity), which may include mismounts (e.g., placing a customer's container on a chassis belonging to a chassis pool to which the customer does not belong), and stacking (e.g., freeing up a chassis from a container by placing the container on a stacked parking lot), etc. In this manner, chassis optimization system 121 may be configured to provide recommendations to increase or reposition the current chassis resource capacity of the hub to further maximize the number of units processed through the hub over the planning horizon given the unit traffic (e.g., the units expected to arrive at the hub through each of the IG and IB flows at each time increment of the planning horizon) predicted in the optimized operating schedule and given the replenished or repositioned chassis resource capacity of the hub. In embodiments, the recommendations provided by chassis optimization system 121 may be based on the dynamic chassis pool classifications generated and/or configured by dynamic chassis pool classification system 122.

In embodiments, the functionality of dynamic chassis pool classification system 122 to dynamically classify chassis pools associated with the hub may include functionality for determining and/or setting a configuration for one or more dynamic chassis pool classifications. The one or more dynamic chassis pool classifications represent a mechanism or framework to manage the various chassis pools associated with the hub to ensure that chassis utilization involving the chassis pools results in a maximized unit throughput while also maintaining a fair and efficient allocation of chassis to containers to addresses the issue of chassis supply fluctuation and the inefficiencies it breeds in container transit stages.

In embodiments, the functionality of dynamic chassis pool classification system 122 leverages the different chassis pool classifications, each with distinct configurations designed to mitigate chassis shortages, balance the dynamic ebbs and flows of chassis demand, and facilitate a smoother flow of units through the hub. By integrating these novel dynamic chassis pool classifications, dynamic chassis pool classification system 122 addresses the challenges posed by the conventional management of chassis pools, where even a single customer's high activity level could disproportionately deplete chassis resources, adversely affecting the operational efficiency of the hub and penalizing other users through delayed operations and increased handling requirements.

In embodiments, the functionality of dynamic chassis pool classification system 122 for determining and/or setting a configuration for one or more dynamic chassis pool classifications may include functionality for generating a configuration of each of the plurality of chassis pool classifications. In embodiments, the configuration for a dynamic chassis classification may include a ruleset for implementing and/or managing the dynamic chassis classification. In embodiments, a chassis pool classified into a particular dynamic chassis classification may operate under the configuration (e.g., may be operated or managed in accordance with the ruleset of the particular dynamic chassis classification) and may abide by the ruleset. In this case, the utilization of chassis (e.g., the drawing or borrowing of a chassis from the chassis pool to hold a container, or the lending of a chassis to the chassis pool) in the chassis pool may be in accordance with the ruleset of the particular dynamic chassis classification. In embodiments, the rulesets of the configurations may offer a robust framework that ensures optimal utilization, fairness in allocation, and enhanced operational efficiency during hub operations involving chassis resources.

In embodiments, the ruleset of a configuration defining a dynamic chassis classification may include one or more operating rules to govern how the chassis in a chassis pool classified with the dynamic chassis classification are utilized, one or more constraints for restricting operations utilizing the chassis in the chassis pool classified with the dynamic chassis classification, one or more operating guidelines to limit utilization of the chassis in the chassis pool classified with the dynamic chassis classification, and/or one or more performance metrics to collect associated with the one or more operating guidelines.

In embodiments, the one or more operating rules of a ruleset of a dynamic chassis classification may define the manner in which chassis may be accessed, used, borrowed, lent, and/or returned to the pool. The one or more operating rules may define, for example, when a customer in a first pool in the dynamic chassis classification may borrow a chassis from a second pool in the dynamic chassis classification, and under what conditions the chassis may be borrowed, when and/or a manner in which a chassis is to be returned to the lending chassis pool, etc.

In embodiments, the one or more constraints may include restrictions put in place to restrict certain operations involving the chassis, to prevent certain conditions, such as loss of chassis resources, reduction in chassis resource inventory levels etc. By implementing such constraints, dynamic chassis pool classification system 122 may mitigate the impact on chassis resource inventory levels of the participating chassis pools. T

In embodiments, the one or more operating guidelines offer a set of limitations on the utilization of the chassis in the participating chassis pools of a dynamic chassis pool classification. The one or more operating guidelines may be configured to mitigate the misuse and overutilization of the chassis resources. In embodiments, the one or more operating guidelines may place limits on the duration a chassis may be used by a single customer of a chassis pool participating in the dynamic chassis pool classification, limits on the number of chassis that may be accessed by a customer at any given time (e.g., including per time increment of the planning horizon of the optimized operating schedule), limits on the overuse of chassis from a lending chassis pool by a borrowing chassis pool, limits on use of chassis resources by customers determined to have misuse violations, overloading violations, and/or other times of misuse, etc.

In embodiments, application of the limits associated with the one or more operating guidelines may be based on whether thresholds. For example, a limit may be applied against a customer participating in the dynamic chassis pool classification when a threshold associated with the limit is exceeded. In embodiments, whether a threshold is exceeded is determined by collecting the one or more performance metrics defined in the ruleset to be collected and associated with the use of chassis resources in the dynamic chassis pool classification, and determining whether the performance metrics indicate that the threshold associated with the limit is exceeded or not.

In embodiments, the one or more performance metrics to be collected may include one or more of a number of chassis borrowed by a customer in a first chassis pool from a second chassis pool, a number of chassis lent by a customer in a first chassis pool to a customer in a second chassis pool, an average duration a customer in a first chassis pool spent lending a chassis to a customer in a second chassis pool, an average duration a customer in a first chassis pool spent borrowing a chassis from a second chassis pool, a number of instances in which a chassis borrowed by a customer was damaged by the customer, a number of instances in which a chassis lent to a customer was damaged by the customer, average weight mounted on each borrowed chassis by a customer borrowing the chassis, a fairness measurement computed for each customer using the following formula: fairness measurement=number of chassis lent*chassis duration lent−number of chassis borrowed*chassis duration borrowed, a total number of chassis in the dynamic chassis classification pool, a contribution level by a customer that includes the number of chassis owned by the customer divided by the total number of chassis in the dynamic chassis classification pool, a number indicating a maximum number of chassis drawn from the dynamic classification pool by a customer overall, a current number of chassis drawn from the dynamic classification pool by a customer, a dwell time for each container owned by a customer in a chassis drawn from the dynamic classification pool, a dwell time for each container owned by a customer in a chassis owned by the customer, a number of instances of misuse by a customer, etc.

In embodiments, the thresholds may include an imbalance threshold to determine whether a customer has borrowed a chassis from a chassis pool significantly more than the number of times the customer has lent a chassis to another customer. In this case, an imbalance measurement for a customer may be calculated using the following formula: (number of chassis borrowed by a customer in a first chassis pool from a second chassis pool−a number of chassis lent by a customer in a first chassis pool to a customer in a second chassis pool)/number of chassis borrowed by a customer in a first chassis pool from a second chassis pool. In embodiments, the imbalance measurement may be compared against an imbalance threshold and if the result exceeds the imbalance threshold, the customer may be limited or prevented from borrowing from the dynamic chassis pool classification, until the imbalance measurement is decreased and does not exceed the threshold.

In embodiments, the thresholds may include a fairness deficit threshold to determine whether the average duration that a customer has borrowed a chassis from the dynamic chassis pool classification is significantly more than the duration that the customer has lent a chassis. In this case, a fairness measurement for a customer may be calculated using the following formula: computed for each customer using the following formula: fairness measurement=number of chassis lent*chassis duration lent−number of chassis borrowed*chassis duration borrowed. In embodiments, the fairness measurement may be compared against a fairness deficit threshold and if the result is less than the fairness deficit threshold, the customer may be limited or prevented from borrowing from the dynamic chassis pool classification, until the fairness measurement is increased to above the threshold.

In embodiments, the thresholds may include a misuse threshold to determine whether the customer misuse of borrowed chassis is beyond acceptable. In this case, the number of instances of misuse by the customer may be compared against the misuse threshold and if the instances of misuse by the customer is greater than the misuse threshold, the customer may be limited or prevented from borrowing from the dynamic chassis pool classification.

In embodiments, the thresholds may include an overloading threshold to determine whether the customer has overloaded the borrowed chassis beyond an acceptable level. In this case, the average weight mounted on each borrowed chassis by the customer may be compared against the overloading threshold and if the average weight is greater than the overloading threshold, the customer may be limited or prevented from borrowing from the dynamic chassis pool classification.

In embodiments, the thresholds may include a number of borrowing instances per time increment threshold to determine whether the customer has borrowed a chassis from the dynamic chassis pool classification too many times per time increment of the planning horizon of the optimized operating schedule. In this case, the number of instances per time increment that the customer has borrowed from the dynamic chassis pool classification may be calculated based on the performance metrics collected. The result may be compared against the number of borrowing instances per time increment threshold and if the number of instances per time increment that the customer has borrowed from the dynamic chassis pool classification is greater than the threshold, the customer may be limited or prevented from borrowing from the dynamic chassis pool classification.

In embodiments, the thresholds may include a maximum withdrawal threshold to determine whether the customer has withdrawn a number of chassis from the dynamic chassis pool classification that is beyond acceptable. In this case, the number chassis that have been withdrawn from the dynamic chassis pool classification by the customer may be computed and compared against the maximum withdrawal threshold. If the number chassis that have been withdrawn from the dynamic chassis pool classification by the customer is greater than the maximum withdrawal threshold, the customer may be limited or prevented from borrowing from the dynamic chassis pool classification.

In embodiments, the thresholds may include a minimum own chassis threshold to determine whether the customer keeps a minimum level of their own chassis in the dynamic chassis pool classification. In this case, the number chassis owned by the customer in the dynamic chassis pool classification may be computed and compared against the minimum own chassis threshold. If the number chassis owned by the customer in the dynamic chassis pool classification is less than the minimum own chassis threshold, the customer may be limited or prevented from borrowing from the dynamic chassis pool classification until the customer add more of their own chassis into the dynamic chassis pool classification.

In a particular example of dynamic chassis classifications, a dynamic chassis classification may include an interim loaner pool classification. In embodiments, the configuration of the interim loaner pool classification may enable implementation of an interim loaner pool by including one or more chassis pools that may be managed in accordance with the ruleset of the interim loaner pool classification configuration.

In particular, the interim loaner pool classification may enable the chassis optimization system 121, and/or operations server 125 to allocate a chassis to a container belonging to a customer associated with a second pool by borrowing the chassis from a first chassis pool and use it to deramp the container and place the container in a parking lot in the hub. However, under the configuration of the interim loaner pool classification, the container may not be allowed to leave the hub (e.g., with the borrowed chassis) until a chassis belonging to the second chassis pool becomes available and the container has been flipped onto the second chassis pool chassis (e.g., the container may leave the hub on the chassis from the second chassis pool).

In embodiments, when the interim loaner pool classification, DSRO system 160 may take into consideration the inventory levels of comparable chassis pools (e.g., classified into the interim loaner pool) and draw from these chassis pools if and only if the chassis pool associated with the customer to whom the container belongs is empty of chassis and deramp activity cannot progress without borrowing. DSRO system 160 may be customized to consider the interim loaner pool classification as a last resort and exhaustively explore all other options such as stacking, holding the units longer etc. In embodiments, DSRO system 160 may track chassis replenishment by the borrowing chassis pool provider during the planning horizon and may assigns loaner chassis from comparable chassis pools only if flips back to the appropriate chassis pool are possible.

In embodiments, the ruleset of the interim loaner pool classification configuration may include operating rules to govern how the chassis in the interim loaner pool are utilized. In particular, the operating rules of the interim loaner pool may specify that a chassis in a first chassis pool (e.g., a first chassis pool classified into the interim loaner pool classification and participating in the interim loaner pool) may be used (e.g., borrowed) to receive a container from a customer associated with a second chassis pool in response to a determination (e.g., by the chassis optimization system 121) that the second chassis pool has a deficit and there is no chassis from the second pool available to receive the container, and that the operational flow associated with the first chassis pool is unaffected (e.g., lending the chassis to the second chassis pool customer will not result in a chassis deficit for the customers associated with the first pool). In this case, the act of deramping the container onto the chassis from the first chassis pool is said to be a mismount. In embodiments, the operating rules of the interim loaner pool may specify that the mismounted container is to be flipped back to a chassis in the second chassis pool when a chassis in the second chassis pool becomes available (e.g., through a deramping operation or through replenishment), and the mismounted chassis in the first chassis pool may be returned to the first chassis pool (e.g., may be considered as available for receiving a container).

In embodiments, the ruleset of the interim loaner pool classification configuration may include constraints for restricting operations utilizing the chassis in the interim loaner pool. In particular, the constraints of the interim loaner pool may specify that a mismounted chassis is not allowed to leave the hub. For example, following the example above, while the mismounted container remains on the chassis from the first chassis pool (e.g., before the container is flipped to a chassis in the second chassis pool), the container is not permitted from leaving the hub. In embodiments, these constraints may prevent the mismounted chassis from being removed from the hub by a customer that is not associated with the first chassis pool.

In embodiments, the ruleset of the interim loaner pool classification configuration may include operating guidelines to limit utilization of the chassis in the interim loaner pool. In particular, the operating guidelines of the interim loaner pool may define an imbalance threshold to limit customers whose imbalance measurement exceeds the imbalance threshold, a fairness deficit threshold to limit customers whose fairness measurement does not exceed the fairness deficit threshold, a misuse threshold to limit customers whose number of misuse instances exceeds the misuse threshold, an overloading threshold to limit customers whose average weight mounted on each chassis borrowed by the customer exceeds the overloading threshold, and a number of borrowing instances per time increment threshold to limit customers whose number of instances per time increment that the customer has borrowed from another chassis pool in the interim loaner pool exceeds the number of borrowing instances per time increment threshold.

In another example of dynamic chassis classifications, a dynamic chassis classification may include a reciprocating pool classification. In embodiments, the configuration of the reciprocating pool classification may enable implementation of a reciprocating pool by including one or more chassis pools that may be managed in accordance with the ruleset of the reciprocating pool classification configuration.

In particular, the reciprocating pool classification may enable the chassis optimization system 121, and/or operations server 125 to allocate chassis between participating chassis pool in a reciprocating manner. For example, a first chassis pool and a second chassis pool may be classified into the reciprocating pool classification. In this case, the first chassis pool and the second chassis pool may be allowed to reciprocate and borrow chassis from each other. Under the reciprocating pool classification, mismounted chassis (e.g., mismounted on a chassis belonging to a reciprocating chassis pool) may be allowed to leave the hub. In embodiments, DSRO system 160 may track the number of chassis contributed into the reciprocating pool by each participating customer, or chassis pool providers, and may ensure that all participating customers, or chassis pool providers, contribute and borrow the same number of chassis, making the net effect in terms of chassis utilization over the optimized operating schedule zero. Under the reciprocating pool classification, chassis pool operators may manage their own pools and may maintain autonomy and, in this case, DSRO system 160 may facilitate chassis swapping between the participating chassis pools.

In embodiments, the ruleset of the reciprocating pool classification configuration may include operating rules to govern how the chassis in the reciprocating pool are utilized. In particular, the operating rules of the reciprocating pool may specify that a chassis from a first pool classified into the reciprocating pool classification may be used to receive a deramped container belonging to a customer associated with the first pool as long as the first pool has a number of available chassis exceeding a supply threshold (e.g., does not have a chassis deficit). However, if the number of available chassis in the first chassis pool does not exceed the supply threshold (e.g., if the first chassis pool has a chassis deficit), a chassis from a second chassis pool classified into the reciprocating pool classification may be borrowed to receive the deramped container. In this case, the act of deramping the container onto the chassis from the second chassis pool is said to be a mismount. In embodiments, the operating rules of the reciprocating pool may specify that the mismounted container is to be flipped back to a chassis from the first chassis pool when the first chassis pool is replenished and no longer has a chassis deficit, and the mismounted chassis in the second chassis pool may be returned to the second chassis pool (e.g., may be considered as available for receiving a container).

In embodiments, the ruleset of the reciprocating pool classification configuration may include constraints for restricting operations utilizing the chassis in the reciprocating pool. In particular, the constraints of the reciprocating pool may specify that a mismounted chassis is in fact allowed to leave the hub, but the constraints may include a restriction on the number of chassis that may be borrowed from the reciprocating pool (e.g., that may be borrowed from a first chassis pool by a customer associated with a second chassis pool).

In embodiments, the ruleset of the reciprocating pool classification configuration may include operating guidelines to limit utilization of the chassis in the reciprocating pool. In particular, the operating guidelines of the reciprocating pool may define an imbalance threshold to limit customers whose imbalance measurement exceeds the imbalance threshold, a fairness deficit threshold to limit customers whose fairness measurement does not exceed the fairness deficit threshold, a misuse threshold to limit customers whose number of misuse instances exceeds the misuse threshold, and an overloading threshold to limit customers whose average weight mounted on each chassis borrowed by the customer exceeds the overloading threshold.

In yet another example of dynamic chassis classifications, a dynamic chassis classification may include a single pool classification. In embodiments, the configuration of the single pool classification may enable implementation of a single pool by pooling all chassis resources belonging to the participating providers or customers, and may present the shared resources as a single pool that may be managed in accordance with the ruleset of the single pool classification configuration. In embodiments, the chassis resources pooled into the single pool may include chassis that may be part of different chassis pools (e.g., each chassis pool designated to one or more customers), but in the single pool these chassis may be treated as a single pool. In embodiments, the single pool classification may provide DSRO system 160 a freedom to assign the chassis resources in the single pool to any customer associated with the single pool, and chassis drawn from the single pool may be allowed to leave the hub even when the chassis are mismounted. In embodiments, DSRO system 160 may be configured to impose limits on how many chassis a single customer may draw from the single pool.

In embodiments, the ruleset of the single pool classification configuration may include operating rules to govern how the chassis in the single pool are utilized. In particular, the operating rules of the single pool may specify that a chassis may be borrowed from the single pool to receive a deramped container belonging to a customer in response to a determination (e.g., by optimization system 121 and/or operations server 125) that a current utilization of the customer is within a pre-allocated share threshold. If the customer's current utilization, which may include a number of chassis drawn from the single pool by the customer over a one or more time increments of the planning horizon, exceeds the pre-allocated share threshold, the customer may be limited or prevented from drawing from the single pool until chassis resources of the single pool are replenished (e.g., by the customer or another customer). In embodiments, the customer's current utilization is collected regularly.

In embodiments, the ruleset of the single pool classification configuration may include constraints for restricting operations utilizing the chassis in the single pool. In particular, the constraints of the single pool may restrict a customer whose current utilization exceeds a pre-allocated share threshold from further drawing from the single pool. In embodiments, the pre-allocated share threshold for the customers may be updated regularly, such as based on inventory levels, available chassis in the single pool, and/or replenishment levels.

In embodiments, the ruleset of the single pool classification configuration may include operating guidelines to limit utilization of the chassis in the single pool. In particular, the operating guidelines of the single pool may define a maximum withdrawal threshold to limit customers who have drawn a number of chassis exceeding the maximum withdrawal threshold, a minimum own chassis threshold to limit customers with a number of chassis owned by the customer in the single pool classification that is less than the minimum own chassis threshold, and a misuse threshold to limit customers whose number of misuse instances exceeds the misuse threshold.

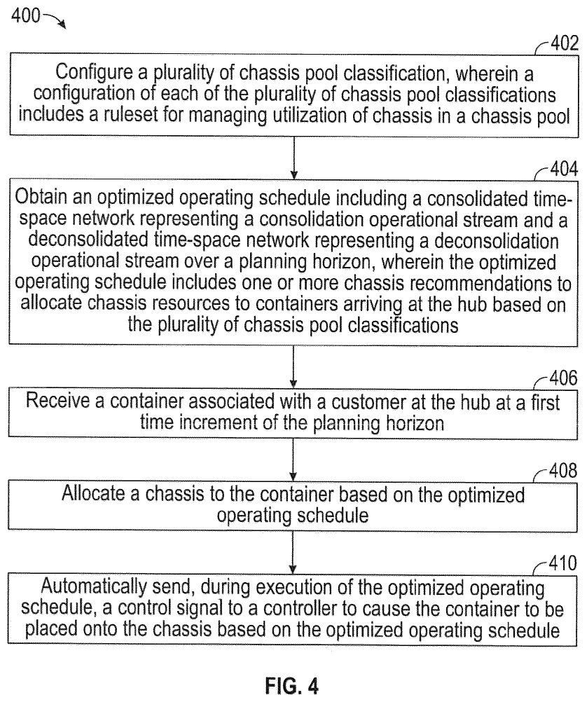

FIG. 4 is a flowchart illustrating operations for allocating chassis to containers based on dynamic chassis pool classifications in accordance with embodiments of the present disclosure. Operations illustrated in FIG. 4 assume operations of a dynamic chassis pool classification system (e.g., dynamic chassis pool classification system 122) to generate one or more dynamic pool classification configurations, and are part of an optimized operating schedule being executed over a planning horizon. The operations illustrated in FIG. 4 may be used by chassis optimization system 121 and/or operations server 125 to allocate a chassis to a container based on dynamic chassis pool classifications.

As shown in FIG. 4, operations may start at block 302 where a container belonging to a customer may be received at the hub (e.g., hub 140 as illustrated in FIG. 1) in an inbound train. The container may be received as part of the IB flow or deconsolidation stream of the hub, and may require a chassis allocation for receiving the container before the container can be unloaded or deramped from the inbound train. In embodiments, at block 304, a determination is made as to whether the customer has a dedicated chassis pool established. In this case, the dedicated chassis pool may be a chassis pool of chassis that belong to the customer, and the customer may have exclusive access to the dedicated chassis pool, without sharing the chassis with any other customer.

Upon a determination, at block 304, that the customer has in fact a dedicated chassis pool established, at block 330, a determination is made as to whether a chassis in the dedicated chassis pool is currently available. In response to a determination that a chassis in the dedicated chassis pool is not currently available, chassis optimization system 121 and/or operations server 125 may determine to recommend that the container be stored in a stacked parking lot. In this case, at block 336, the container may be placed in a container stack (e.g., one container on top of each other, and sitting on the ground or a platform instead of a chassis) instead of being placed on a chassis and in a parking lot space, and may wait, at block 338, in the stacked parking lot until a chassis from the dedicated chassis pool is available (e.g., from a deramping event, from a replenishment event, etc.). Once a chassis from the dedicated chassis pool is available for the container, the chassis from the dedicated chassis pool is fetched, and operations flow to block 348.

On the other hand, in response to a determination that a chassis from the dedicated chassis pool is currently available, the chassis from the dedicated chassis pool may be fetched at block 332, and operations may flow to block 348. At block 348, the container is loaded onto the fetched chassis (e.g., the chassis from the dedicated chassis pool). Operations then flow to block 352.

Referring back to block 304, in response to a determination that a dedicated chassis pool has not been established for the customer to whom the container belongs, a determination is made, at block 306, as to whether the customer has been designated into a non-dedicated chassis pool. A non-dedicated chassis pool may include a chassis pool in which chassis from a single chassis provider may be pooled to be used by customers participating in or designated into the chassis pool. In response to a determination that the customer has been designated into a non-dedicated chassis pool, a chassis from the non-dedicated chassis pool may be fetched at block 307, and operations may flow to block 348, where the container is loaded onto the fetched chassis (e.g., the chassis from the non-dedicated chassis pool). Operations then flow to block 352.

On the other hand, in response to a determination, at 306, that the customer has not been designated into a non-dedicated chassis pool, a determination is made, at block 308, as to whether a dynamic classification has been configured. In response to a determination that a single pool classification has been configured, the single pool configuration for a single pool may be obtained at block 322. At block 324, as determination may be made as to whether, based on the configuration of the single pool, and based on the ruleset of the single pool, the customer is allowed to draw a chassis from the single pool. For example, the determination as to whether the customer is allowed to draw a chassis from the single pool may include a determination as to whether the customer is limited or prevented from drawing from the single pool, etc. In response to a determination that the customer is allowed to draw a chassis from the single pool, a chassis is drawn from the single pool and allocated to the customer and the single pool inventory is updated, at block 326, to reflect the allocation. At block 328, the chassis from the single pool is fetched and operations may flow to block 348, where the container is loaded onto the fetched chassis (e.g., the chassis from the single pool). Operations then flow to block 352.

On the other hand, in response to a determination, at block 324, that the customer is not allowed to draw a chassis from the single pool (e.g., may be limited, may not meet the operating guidelines, may not meet the operating rules, etc.), a determination is made, at block 325, as to whether the customer is a participant in a reciprocating pool. In response to determination that the customer is not a participant in a reciprocating pool, chassis optimization system 121 and/or operations server 125 may determine to recommend that the container be stored in a stacked parking lot. At block 336, the container may be placed in a container stack, and may wait, at block 338, in the stacked parking lot until a chassis that may receive the container becomes available (e.g., from a deramping event, from a replenishment event, etc.). Once a chassis that may receive the container is available for the container, the chassis is fetched, and operations flow to block 348, where the container is loaded onto the fetched chassis (e.g., the customer chassis). Operations then flow to block 352.

With reference back to block 325, in response to a determination that the customer is a participant in a reciprocating pool, operations flow to block 314. At block 314, the reciprocating pool configuration for a reciprocating pool may be obtained. At block 316, a determination may be made as to whether, based on the configuration of the reciprocating pool, and based on the ruleset of the reciprocating pool, the customer is allowed to be allocated a chassis from the reciprocating pool. For example, the determination as to whether the customer is allowed to borrow a chassis from the reciprocating pool may include a determination as to whether the customer is limited or prevented from drawing from the reciprocating pool, a determination as to whether borrowing a chassis to receive the container may meet the operating guidelines or not, determination as to whether borrowing a chassis to receive the container may meet the operating rules, etc. In response to a determination that the customer is allowed to borrow a chassis from the reciprocating pool, a chassis is drawn from the reciprocating pool and allocated to the customer and the reciprocating pool inventory is updated, at block 318, to reflect the allocation. At block 320, the chassis from the reciprocating pool is fetched and operations may flow to block 348, where the container is loaded onto the fetched chassis (e.g., the chassis from the reciprocating pool). Operations then flow to block 352.

On the other hand, in response to a determination, at block 316, that the customer is not allowed to borrow a chassis from the reciprocating pool (e.g., may be limited, may not meet the operating guidelines, may not meet the operating rules, etc.), a determination is made, at block 312, as to whether the customer is a participant in an interim loaner pool. In response to determination that the customer is not a participant in an interim loaner pool, chassis optimization system 121 and/or operations server 125 may determine to recommend that the container be stored in a stacked parking lot. At block 336, the container may be placed in a container stack, and may wait, at block 338, in the stacked parking lot until a chassis that may receive the container becomes available (e.g., from a deramping event, from a replenishment event, etc.). Once a chassis that may receive the container is available for the container, the chassis is fetched at block 340, and operations flow to block 348, where the container is loaded onto the fetched chassis. Operations then flow to block 352.

With reference back to block 312, in response to a determination that the customer is a participant in an interim loaner pool, operations flow to block 310. At block 310, the interim loaner pool configuration for an interim loaner pool may be obtained. At block 334, a determination may be made as to whether, based on the configuration of the interim loaner pool, and based on the ruleset of the interim loaner pool, the customer is allowed to be allocated a chassis from the interim loaner pool. For example, the determination as to whether the customer is allowed to borrow a chassis from the interim loaner pool may include a determination as to whether the customer is limited or prevented from drawing from the interim loaner pool, a determination as to whether borrowing a chassis to receive the container may meet the operating guidelines of the interim loaner pool or not, a determination as to whether borrowing a chassis to receive the container may meet the operating rules of the interim loaner pool or not, etc. In response to a determination that the customer is allowed to borrow a chassis from the interim loaner pool, a chassis is borrowed from the interim loaner pool and allocated to the customer.

At block 342, the container is mismounted onto the borrowed chassis. A mismount may include when a chassis belonging to a chassis pool is used to receive a container belonging to a customer that does not belong to the chassis pool. In this case, the mismounted container and the mismounted chassis belonging to the interim loaner pool may be placed on a parking space of a parking lot of the hub and may wait, at block 344, until a chassis that may receive the container becomes available (e.g., from a deramping event, from a replenishment event, etc.). Once a chassis that may receive the container is available for the container, the chassis is fetched at block 346, and operations flow to block 348, where the container is loaded onto the fetched chassis. Operations then flow to block 352.

At block 352, the container mounted on the chassis is placed into a parking space of a parking lot of the hub. At block 354, a notification may be sent to the customer that the container is ready for pickup by the customer, and at block 356 the system waits for the customer to pick up the container. At block 358, the customer may pick up the container along with the chassis on which the container is mounted and may leave the hub ending the process at block 360.

FIG. 4 shows a high-level flow diagram 400 of operation of a system configured for providing functionality for allocating chassis resources of a hub based on dynamic classification of chassis pools associated with the hub in accordance with embodiments of the present disclosure. For example, the functions illustrated in the example blocks shown in FIG. 4 may be performed by system 100 of FIG. 1 according to embodiments herein. In embodiments, the operations of the method 400 may be stored as instructions that, when executed by one or more processors, cause the one or more processors to perform the operations of the method 400.

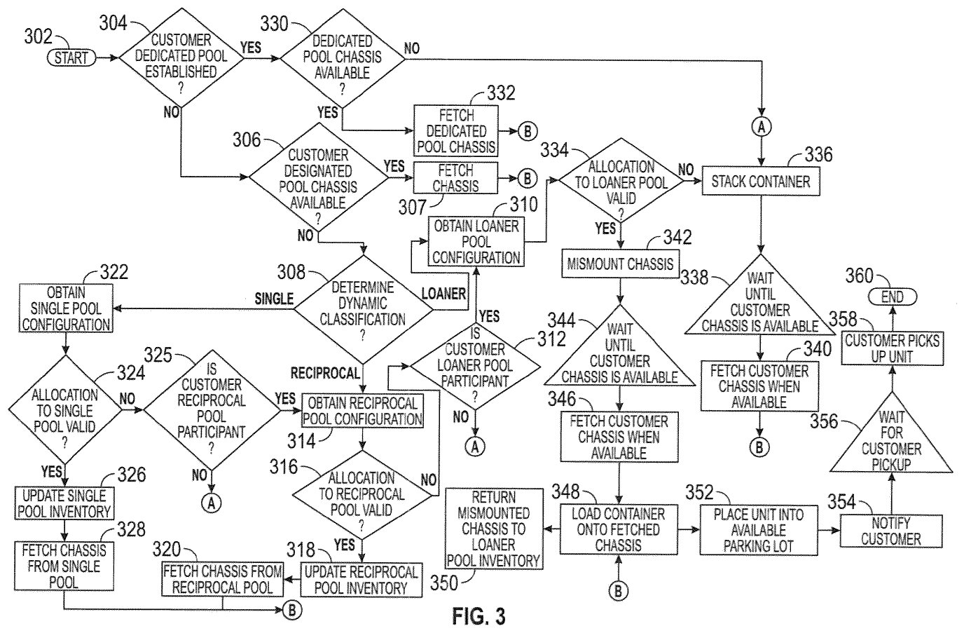

At block 402, a plurality of chassis pool classification is configured. In embodiments, a configuration of each of the plurality of chassis pool classifications includes a ruleset for managing utilization of chassis in a chassis pool. In embodiments, functionality of a dynamic chassis pool classification system (e.g., dynamic chassis pool classification system 122 as illustrated in FIG. 2) may be used to configure a plurality of chassis pool classification. In embodiments, the dynamic chassis pool classification system may perform operations to configure a plurality of chassis pool classification according to operations and functionality as described above with reference to dynamic chassis pool classification system 122 and as illustrated in FIGS. 1-3.

At block 404, an optimized operating schedule including a consolidated time-space network representing a consolidation operational stream and a deconsolidated time-space network representing a deconsolidation operational stream over a planning horizon is obtained. In embodiments, the optimized operating schedule includes one or more chassis recommendations to allocate chassis resources to containers arriving at the hub based on the plurality of chassis pool classifications. In embodiments, functionality of a resource optimization system (e.g., resource optimization system 129 as illustrated in FIG. 2) may be used to obtain an optimized operating schedule including a consolidated time-space network representing a consolidation operational stream and a deconsolidated time-space network representing a deconsolidation operational stream over a planning horizon. In embodiments, the resource optimization system may perform operations to obtain an optimized operating schedule including a consolidated time-space network representing a consolidation operational stream and a deconsolidated time-space network representing a deconsolidation operational stream over a planning horizon according to operations and functionality as described above with reference to resource optimization system 129 and as illustrated in FIGS. 1-3.

At block 406, receive a container associated with a customer at the hub at a first time increment of the planning horizon. In embodiments, functionality of an operations server (e.g., operations server 125 as illustrated in FIGS. 1 and 2) may be used to receive a container associated with a customer at the hub at a first time increment of the planning horizon. In embodiments, the operations server may perform operations to receive a container associated with a customer at the hub at a first time increment of the planning horizon according to operations and functionality as described above with reference to operations server 125 and as illustrated in FIGS. 1-3.

At block 408, a chassis is allocated to the container based on the optimized operating schedule. In embodiments, functionality of a chassis optimization system and/or an operations server (e.g., chassis optimization system 121 and/or operations server 125 as illustrated in FIG. 2) may be used to allocate a chassis to the container based on the optimized operating schedule. In embodiments, the chassis optimization system and/or operations server may perform operations to allocate chassis to the container based on the optimized operating schedule according to operations and functionality as described above with reference to chassis optimization system 125 and/or operations server 125 and as illustrated in FIGS. 1-3.

At block 410, a control signal is automatically sent to a controller to cause the container to be placed onto the chassis based on the optimized operating schedule during execution of the optimized operating schedule. In embodiments, functionality of an operations server (e.g., operations server 125 as illustrated in FIGS. 1 and 2) may be used to automatically send, during execution of the optimized operating schedule, a control signal to a controller to cause the container to be placed onto the chassis based on the optimized operating schedule. In embodiments, the operations server may perform operations to automatically send, during execution of the optimized operating schedule, a control signal to a controller to cause the container to be placed onto the chassis based on the optimized operating schedule according to operations and functionality as described above with reference to operations server 125 and as illustrated in FIGS. 1-3.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-4 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of allocating chassis resources of a hub based on dynamic classification of chassis pools associated with the hub, comprising:
configuring a plurality of chassis pool classification, wherein a configuration of each of the plurality of chassis pool classifications includes a ruleset for managing utilization of chassis in a chassis pool;
obtaining an optimized operating schedule including a consolidated time-space network representing a consolidation operational stream and a deconsolidated time-space network representing a deconsolidation operational stream over a planning horizon, wherein the optimized operating schedule includes one or more chassis recommendations to allocate chassis resources to containers arriving at the hub based on the plurality of chassis pool classifications;
receiving a container associated with a customer at the hub at a first time increment of the planning horizon;
allocating a chassis to the container based on the optimized operating schedule; and
automatically sending, during execution of the optimized operating schedule, a control signal to a controller to cause the container to be placed onto the chassis based on the optimized operating schedule.

2. The method of claim 1, wherein a ruleset of a dynamic chassis pool classification includes one or more of:
one or more operating rules to govern how chassis in a chassis pool classified with the dynamic chassis classification are utilized;
one or more constraints for restricting operations utilizing the chassis in a chassis pool classified with the dynamic chassis classification;
one or more operating guidelines to limit utilization of the chassis in a chassis pool classified with the dynamic chassis classification; and
one or more performance metrics to collect associated with the one or more operating guidelines.

3. The method of claim 2, wherein the one or more operating rules for an interim loaner chassis pool classification for implementing an interim loaner pool include:
permitting borrowing a chassis from a first pool to receive a deramped container belonging to a customer associated with a second pool in response to a determination that a chassis from the second pool is not currently available to receive the deramped container;
requiring the container to be flipped to a chassis from the second pool once the chassis from the second pool is available to receive the container; and
returning the chassis from the first pool to the interim loaner pool once the container is flipped to the chassis from the second pool.

4. The method of claim 3, wherein the one or more constraints include:
preventing the chassis from the first pool from being removed from the hub while the container remains mounted on the chassis from the first pool.

5. The method of claim 3, wherein the one or more operating guidelines include one or more of:
an imbalance threshold to limit customers whose imbalance measurement exceed the imbalance threshold;
a fairness deficit threshold to limit customers whose fairness measurement does not exceed the fairness deficit threshold;
a misuse threshold to limit customers whose number of misuse instances exceeds the misuse threshold;
an overloading threshold to limit customers whose average weight mounted on each borrowed chassis exceeds the overloading threshold; and
a number of borrowing instances per time increment threshold to limit customers whose number of instances per time increment that the customers have borrowed from another chassis pool in the interim loaner pool exceeds the number of borrowing instances per time increment threshold.

6. The method of claim 2, wherein the one or more operating rules for a reciprocating chassis pool classification for implementing a reciprocating pool includes:
permitting borrowing a chassis from a first pool to receive a deramped container belonging to a customer associated with a second pool in response to a determination that a number of chassis from the second pool currently available to receive a container is below a supply threshold;
requiring the container to be flipped to a chassis from the second pool once the number of chassis from the second pool currently available to receive a container is no longer below the supply threshold; and
returning the chassis from the first pool to the reciprocating pool once the container is flipped to the chassis from the second pool.

7. The method of claim 6, wherein the one or more constraints of the reciprocating chassis pool classification include:
preventing a participant of the reciprocating pool from borrowing further chassis in response to a determination that a number of chassis borrowed from the reciprocating pool by the participant exceeds a borrowing threshold; and
allowing the chassis from the first pool to be removed from the hub while the container remains mounted on the chassis from the first pool.

8. The method of claim 6, wherein the one or more operating guidelines include one or more of:
an imbalance threshold to limit customers whose imbalance measurement exceed the imbalance threshold;
a fairness deficit threshold to limit customers whose fairness measurement does not exceed the fairness deficit threshold;
a misuse threshold to limit customers whose number of misuse instances exceeds the misuse threshold; and
an overloading threshold to limit customers whose average weight mounted on each borrowed chassis exceeds the overloading threshold.

9. The method of claim 2, wherein the one or more operating rules for a single chassis pool classification for implementing a single pool includes:
determining whether a current utilization of a customer exceeds a pre-allocated share threshold;
permitting the customer to draw a chassis from the single pool to receive a deramped container belonging to the customer in response to a determination the current utilization of the customer does not exceed the pre-allocated share threshold; and
preventing the customer from drawing a chassis from the single pool to receive the deramped container belonging to the customer in response to a determination the current utilization of the customer exceeds the pre-allocated share threshold.

10. The method of claim 9, wherein the one or more constraints of the single chassis pool classification include:
establishing a borrowing limit for each participant of the single pool; and
dynamically modifying the borrowing limits for each participant based on replenishment levels of the chassis in the single pool.

11. The method of claim 9, wherein the one or more operating guidelines include one or more of:
a maximum withdrawal threshold to limit customers who have drawn a number of chassis from the single pool exceeding the maximum withdrawal threshold;
a minimum own chassis threshold to limit customers with a number of chassis owned by the customers in the single pool that is less than the minimum own chassis threshold; and
a misuse threshold to limit customers whose number of misuse instances exceeds the misuse threshold.

12. A system configured for dynamic classification of chassis pools associated with a hub, comprising:
at least one processor; and
a memory operably coupled to the at least one processor and storing processor-readable code that, when executed by the at least one processor, is configured to perform operations including:
configuring a plurality of chassis pool classification, wherein a configuration of each of the plurality of chassis pool classifications includes a ruleset for managing utilization of chassis in a chassis pool;
obtaining an optimized operating schedule including a consolidated time-space network representing a consolidation operational stream and a deconsolidated time-space network representing a deconsolidation operational stream over a planning horizon, wherein the optimized operating schedule includes one or more chassis recommendations to allocate chassis resources to containers arriving at the hub based on the plurality of chassis pool classifications;
receiving a container associated with a customer at the hub at a first time increment of the planning horizon;
allocating a chassis to the container based on the optimized operating schedule; and
automatically sending, during execution of the optimized operating schedule, a control signal to a controller to cause the container to be placed onto the chassis based on the optimized operating schedule.

13. The system of claim 12, wherein a ruleset of a dynamic chassis pool classification includes one or more of:
one or more operating rules to govern how chassis in a chassis pool classified with the dynamic chassis classification are utilized;
one or more constraints for restricting operations utilizing the chassis in a chassis pool classified with the dynamic chassis classification;
one or more operating guidelines to limit utilization of the chassis in a chassis pool classified with the dynamic chassis classification; and
one or more performance metrics to collect associated with the one or more operating guidelines.

14. The system of claim 13, wherein the one or more operating rules for an interim loaner chassis pool classification for implementing an interim loaner pool include:
permitting borrowing a chassis from a first pool to receive a deramped container belonging to a customer associated with a second pool in response to a determination that a chassis from the second pool is not currently available to receive the deramped container;
requiring the container to be flipped to a chassis from the second pool once the chassis from the second pool is available to receive the container; and
returning the chassis from the first pool to the interim loaner pool once the container is flipped to the chassis from the second pool.

15. The system of claim 14, wherein the one or more constraints include:
preventing the chassis from the first pool from being removed from the hub while the container remains mounted on the chassis from the first pool.

16. The system of claim 14, wherein the one or more operating guidelines include one or more of:
an imbalance threshold to limit customers whose imbalance measurement exceed the imbalance threshold;
a fairness deficit threshold to limit customers whose fairness measurement does not exceed the fairness deficit threshold;
a misuse threshold to limit customers whose number of misuse instances exceeds the misuse threshold;
an overloading threshold to limit customers whose average weight mounted on each borrowed chassis exceeds the overloading threshold; and
a number of borrowing instances per time increment threshold to limit customers whose number of instances per time increment that the customers have borrowed from another chassis pool in the interim loaner pool exceeds the number of borrowing instances per time increment threshold.

17. The system of claim 13, wherein the one or more operating rules for a reciprocating chassis pool classification for implementing a reciprocating pool includes:
permitting borrowing a chassis from a first pool to receive a deramped container belonging to a customer associated with a second pool in response to a determination that a number of chassis from the second pool currently available to receive a container is below a supply threshold;
requiring the container to be flipped to a chassis from the second pool once the number of chassis from the second pool currently available to receive a container is no longer below the supply threshold; and
returning the chassis from the first pool to the reciprocating pool once the container is flipped to the chassis from the second pool.

18. The system of claim 17, wherein the one or more operating guidelines include one or more of:
an imbalance threshold to limit customers whose imbalance measurement exceed the imbalance threshold;
a fairness deficit threshold to limit customers whose fairness measurement does not exceed the fairness deficit threshold;
a misuse threshold to limit customers whose number of misuse instances exceeds the misuse threshold; and
an overloading threshold to limit customers whose average weight mounted on each borrowed chassis exceeds the overloading threshold.

19. The system of claim 13, wherein the one or more operating rules for a single chassis pool classification for implementing a single pool includes:
determining whether a current utilization of a customer exceeds a pre-allocated share threshold;
permitting the customer to draw a chassis from the single pool to receive a deramped container belonging to the customer in response to a determination the current utilization of the customer does not exceed the pre-allocated share threshold; and
preventing the customer from drawing a chassis from the single pool to receive the deramped container belonging to the customer in response to a determination the current utilization of the customer exceeds the pre-allocated share threshold.

20. A computer-based tool for dynamic classification of chassis pools associated with a hub, the computer-based tool including non-transitory computer readable media having stored thereon computer code which, when executed by a processor, causes a computing device to perform operations comprising:
configuring a plurality of chassis pool classification, wherein a configuration of each of the plurality of chassis pool classifications includes a ruleset for managing utilization of chassis in a chassis pool;
obtaining an optimized operating schedule including a consolidated time-space network representing a consolidation operational stream and a deconsolidated time-space network representing a deconsolidation operational stream over a planning horizon, wherein the optimized operating schedule includes one or more chassis recommendations to allocate chassis resources to containers arriving at the hub based on the plurality of chassis pool classifications;
receiving a container associated with a customer at the hub at a first time increment of the planning horizon;
allocating a chassis to the container based on the optimized operating schedule; and
automatically sending, during execution of the optimized operating schedule, a control signal to a controller to cause the container to be placed onto the chassis based on the optimized operating schedule.
